(19) United States
(12) Patent Application Publication
(10) Pub. No.: US 2002/0154230 A1
(43) Pub. Date: Oct. 24, 2002

(54) Camera and method of processing images taken by such an apparatus

(76) Inventor: Frederic Bompard, Massy (FR)

Correspondence Address: U.S. Philips Corporation, 580 White Plains Road, Tarrytown, NY, 10591, US

(21) Appl. No.: 10/104,952

(22) Filed: Mar. 22, 2002

(30) Foreign Application Priority Data
Mar. 27, 2001 (FR) 0104110

(51) Int. Cl. H04N 9/04

(52) U.S. Cl. 348/273; 348/280

(57) ABSTRACT

This camera is formed by a sensor (3) composed of elements sensitive to various color components in the view exhibiting an entire spectrum of spatial frequencies, and at least a first image filtering device (10) for the low frequencies in the spectrum with a view to processing the signals issuing from said sensitive elements.

This apparatus is in essence formed by a first branch (B1) in which said first filtering device (10) and by a second branch (B2) in which a second filtering device (12) is inserted for the high frequencies of the spectrum in order to filter all the signals issuing from said elements and a combination device for supplying an image taking account of the output signals of said branches. In this manner a good sharpness of the image is obtained.

The invention relates to a camera formed by a sensor composed of elements sensitive to various color components in the view exhibiting an entire spectrum of spatial frequencies, and at least a first image filtering device for the low frequencies in the spectrum with a view to processing the signals issuing from said sensitive elements.

The invention also relates to a method of processing images taken by such an apparatus.

An apparatus of this type is described in Japanese patent document 07-284110. In this document, it is proposed to filter the various color components of the image with a view to increasing the resolution of the image obtained from the view.

The present invention proposes an apparatus of the type mentioned in the preamble which has an appreciable simplification in filtering and which gives a sharpness to the images without using too many filtration calculations.

For this purpose, such an apparatus is characterized in that it has a first branch in which said first filtering device is inserted, at least a second branch in which a second filtering device is inserted for the high frequencies of the spectrum in order to filter all the signals issuing from said elements and a combination device for supplying an image taking account of the output signals of said branches.

A method implemented in such an apparatus is characterized in that it includes the following steps:

impression of the sensor composed of elements sensitive to the various color components of the view,

processing the information from this sensor by a first processing branch operating on the color-sensitive elements,

processing the information from this sensor by a second processing branch operating on all the elements without taking account of the color and operating on the upper part of the spatial spectrum,

combination of the various items of information produced by said branches in order to supply an image for use.

The idea of the invention therefore consists of adding image information without taking account of the color and therefore using all the points on the sensor. The human eye is much more sensitive to luminance transitions than to color transitions.

The invention will be further described with reference to examples of embodiment shown in the drawings to which, however, the invention is not restricted:

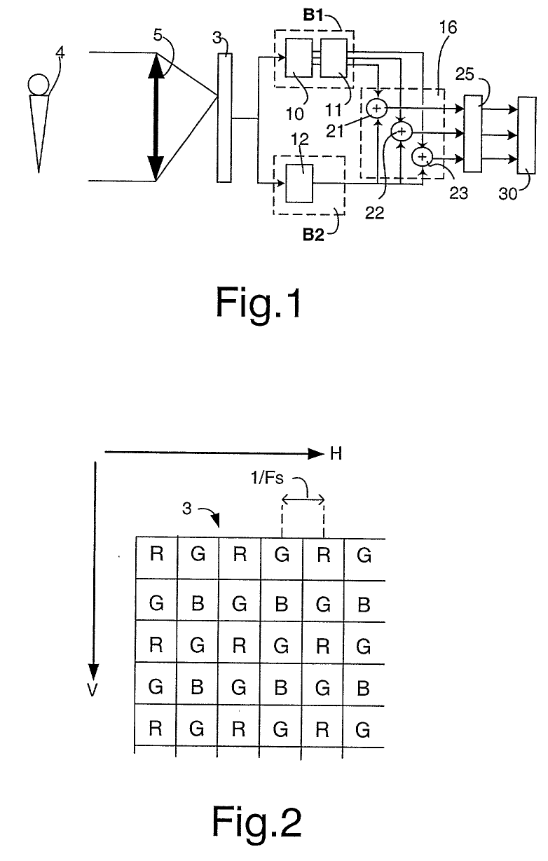

FIG. 1 shows a diagram of the apparatus according to the invention.

FIG. 2 shows in more detail the structure of an apparatus according to the invention.

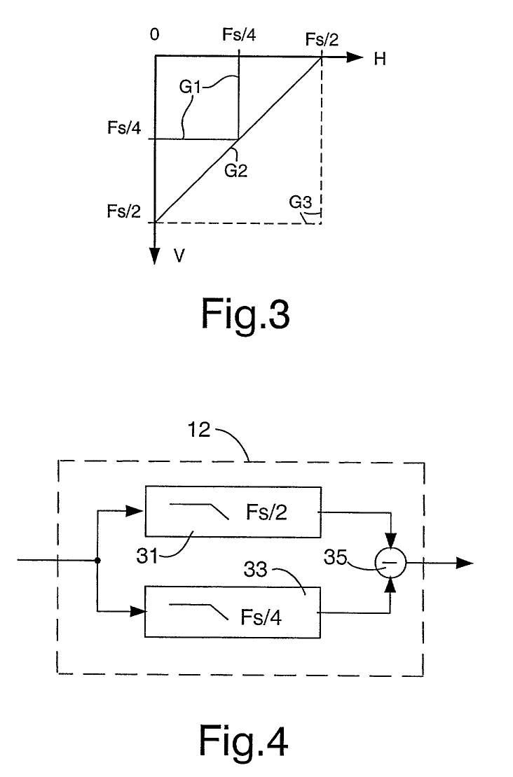

FIG. 3 shows the outline of the spatial spectrum processed by the apparatus in accordance with the invention.

FIG. 4 shows an example of the design of the filtering device for the high frequencies of the spectrum forming part of the apparatus according to the invention.

FIG. 1 shows a camera according to the invention. The reference 3 indicates the sensor having a plurality of elements sensitive to various color components. The sensor is shown in more detail in FIG. 2. The subject 4, which is obtained by a lens 5, is focused onto this sensor.

The various elements of this sensor, disposed in a matrix in horizontal H and vertical V directions, are sensitive to the three primary colors:

blue, these elements are indicated by the letter “B” in FIG. 2

red, these elements are indicated by the letter “R” in FIG. 2

green, these elements are indicated by the letter “G” in this same FIG. 2.

At the output of this sensor, it is possible to collect various signals corresponding to each of said color components. These various color components undergo a filtering operation performed by a first filtering device 10 (FIG. 1). This operation consists of a filtering at two dimensions 2D normal for this type of apparatus and its purpose is to prevent the moire effect due to spectral overlaps. A color reconstruction filtering 11 is also inserted in the branch B1. This filtering regularizes the perception of the colors.

According to the invention this filtering device 10 is put in a first branch B1, while a second filtering device 12 intended to improve the sharpness of the image is inserted in a second branch B2. The filtering device 12 operates on the signals of all the elements of the sensor 3 without taking account of their sensitivity to the various color components.

A combination device 16 combines the various signals issuing from the branches B1 and B2. This combination is a simple addition of on the one hand the signals issuing from the contour improvement filter and on the other hand the signals relating to each of the color components issuing from the branch B1. Three adders 21, 22 and 23 are provided for performing this addition.

Instead of having image information presented in the form of the components thereof in said primary colors red, green and blue, it is wished to have the information in the form known as Y, U, V. These various components Y, U and V represent respectively the luminance, information on the red and information on the blue. This form Y, U and V is particularly used for television signals. This operation is performed by means of a conversion device 25. If it is preferred to deal only with the signals R, G, B, this conversion device 25 can be considered to be a unitary filtering matrix, and therefore carry out no conversion. The information thus processed is finally stored in a memory 30, from which the images thus taken can be taken.

The design of the various processing devices 10, 12 will be considered.

### Device 10

The purpose of the device 10 is to filter the image according to a template shown by the reference G1 in FIG. 3. This FIG. 3 shows the outline, in a quadrant in space, of the various spectra in said directions H and V. This is a low-pass filter which allows the spectral components of less than Fs/4 to pass.

1/Fs represents the distance between pixels (FIG. 2). The template G2 represents the filtering on the pixels G which are favored by the distribution made on the matrix shown in FIG. 2.

### Device 12

The purpose of the device 12 is to filter the image according to a template shown by the reference G3 in FIG. 3. This is a bandpass filter which allows the spectral components greater than Fs/4 and less than Fs/2 to pass. It is associated with two gains G_{R} and G_{B} which compensate for the differences in efficiency of the color filters R and B with respect to the filter G. In practice this bandpass filter is produced, as shown in FIG. 4, by means of two low-pass filters 33 and 31 in order to filter with, respectively, components Fs/4 and Fs/2 considered to be cut-off frequencies and a subtraction device 35 for signals at the output of these filters so as to remove the contribution of the spectrum 0-Fs/4 to the low-pass filter 0-Fs/2.

1. A camera formed by a sensor composed of elements sensitive to various color components in the view exhibiting an entire spectrum of spatial frequencies, and at least a first image filtering device for the low frequencies in the spectrum with a view to processing the signals issuing from said sensitive elements, characterized in that it has a first branch in which said first filtering device is inserted, at least a second branch in which a second filtering device is inserted for the high frequencies of the spectrum in order to filter all the signals issuing from said elements and a combination device for supplying an image taking account of the output signals of said branches.

2. A camera as claimed in claim 1, characterized in that the second filtering device consists of two low-pass filters, one with a narrow spectrum and another with a broad spectrum, and a subtraction device for removing the contribution of the low-pass filter in the filtered spectrum of the broad-spectrum filter.

3. A photographing method, characterized in that it includes the following steps:
impression of the sensor composed of elements sensitive to the various color components of the view,
processing the information from this sensor by a first processing branch operating on the color-sensitive elements,
processing the information from this sensor by a second processing branch operating on all the elements without taking account of the color and operating on the upper part of the spatial spectrum,
combination of the various items of information produced by said branches in order to supply an image for use.
